(19) United States
(12) Patent Application Publication
(10) Pub. No.: US 2026/0303684 A1
(43) Pub. Date: Oct. 1, 2026

(54) P2P GROUP TRUST VERIFICATION MECHANISM

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Frisco, TX (US); Bilal Sadiq, Plano, TX (US)

(21) Appl. No.: 19/562,669

(22) Filed: Mar. 10, 2026

Related U.S. Application Data
(60) Provisional application No. 63/778,202, filed on Mar. 26, 2025.

(51) Int. Cl. H04L 67/1074; H04L 67/104

(52) U.S. Cl. CPC H04L 67/1074; H04L 67/1044

(57) ABSTRACT

A method for operating an access point (AP) includes receiving a group resource request from a first station (STA). The group resource request indicates that at least one second STA is in a same peer-to-peer (P2P) group as the first STA. The method further includes determining whether to verify inclusion of the at least one second STA in the same P2P group as the first STA; and transmitting a response to the first STA indicating whether the AP needs to verify inclusion of the at least one second STA in the same P2P group as the first STA.

### CROSS-REFERENCE TO RELATED APPLICATIONS AND CLAIM OF PRIORITY

This application claims priority under 35 U.S.C. § 119(e) to U.S. Provisional Patent Application No. 63/778,202 filed on Mar. 26, 2025. The above-identified provisional patent application is hereby incorporated by reference in their entirety.

### TECHNICAL FIELD

This disclosure relates generally to wireless networks. More specifically, this disclosure relates to a peer-to-peer (P2P) group trust mechanism.

### BACKGROUND

Wireless local area network (WLAN) technology allows devices to access the internet in the 2.4 GHz, 5GHz, 6GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

This disclosure provides apparatuses and methods for a P2P group trust mechanism.

In one embodiment, a method for operating an access point (AP) includes receiving a group resource request from a first station (STA). The group resource request indicates that at least one second STA is in a same P2P group as the first STA. The method further includes determining whether to verify inclusion of the at least one second STA in the same P2P group as the first STA; and transmitting a response to the first STA indicating whether the AP needs to verify inclusion of the at least one second STA in the same P2P group as the first STA.

In another embodiment, a method for operating a first STA includes transmitting a group resource request to an AP. The group resource request indicates that at least one second STA is in a same P2P group as the first STA. The method further includes receiving a response from the AP indicating whether the AP needs to verify inclusion of the at least one second STA in the same P2P group as the first STA.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP multi-link device (MLD) according to various embodiments of the present disclosure;

FIG. 2B illustrates an example non-AP MLD according to various embodiments of this disclosure;

FIG. 3 illustrates an example of a network where infrastructure traffic and non-infrastructure traffic coexist according to various embodiments of this disclosure;

FIG. 4 illustrates a P2P group according to various embodiments of the present disclosure;

FIG. 5 illustrates a P2P group according to various embodiments of the present disclosure;

FIG. 6 illustrates an example procedure for P2P group trust verification according to various embodiments of the present disclosure;

FIG. 7 illustrates an example procedure for P2P group trust verification that includes a verification request according to various embodiments of the present disclosure;

FIG. 8 illustrates an example procedure for P2P group trust verification that includes a verification in response to a verification request according to various embodiments of the present disclosure;

FIG. 9 illustrates an example procedure for P2P group trust verification that is based on a traffic identifier according to various embodiments of the present disclosure;

FIG. 10 illustrates an example procedure for P2P group trust verification that is based on a traffic identifier according to various embodiments of the present disclosure;

FIG. 11 illustrates an example procedure for P2P group trust verification that is based on a challenge question and/or an identifier according to various embodiments of the present disclosure;

FIG. 12 illustrates an example procedure for P2P group trust verification that is based on a challenge question and/or an identifier according to various embodiments of the present disclosure; and

FIG. 13 illustrates an example procedure for P2P group trust verification that includes a revocation of trust according to various embodiments of the present disclosure.

### DETAILED DESCRIPTION

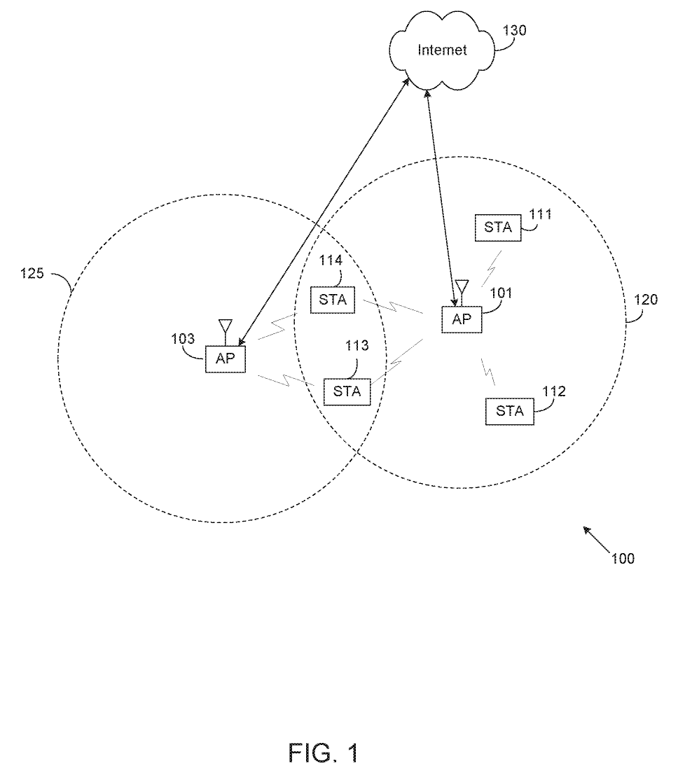

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

The following documents and standards descriptions are hereby incorporated into the present disclosure as if fully set forth herein: [1] IEEE P802.11be –D3.0“Part 11: Wireless LAN Medium Access Control (MAC) and Physical Layer (PHY) Specifications--Amendment 8: Enhancements for extremely high throughput (EHT) and [2] IEEE P802.11REVme –D2.1“Part 11: Wireless LAN Medium Access Control (MAC) and Physical Layer (PHY) Specifications.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for a peer-to-peer (P2P) group trust verification mechanism. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

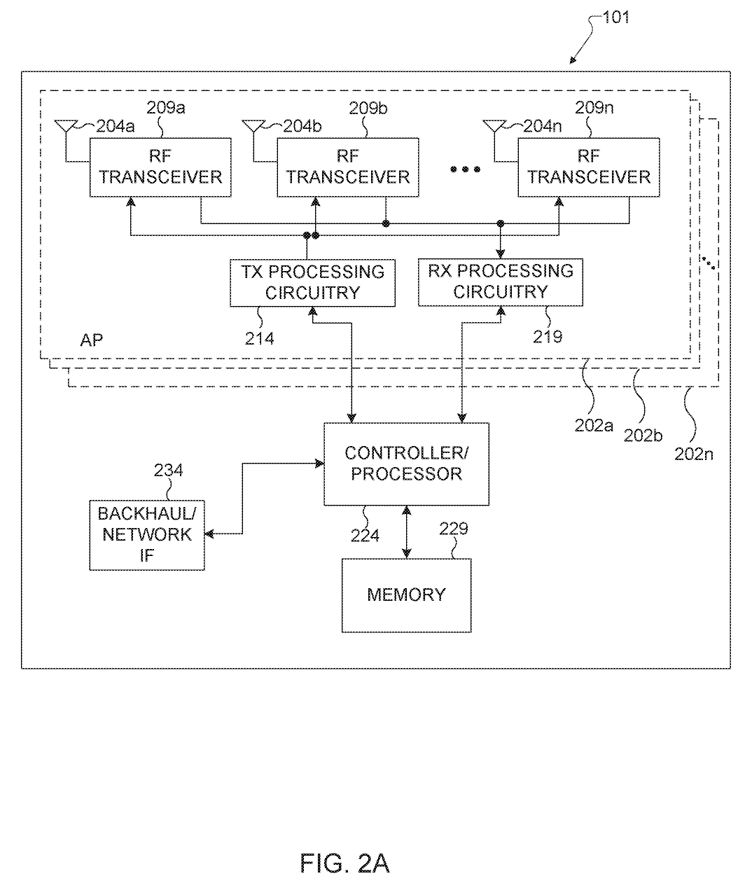

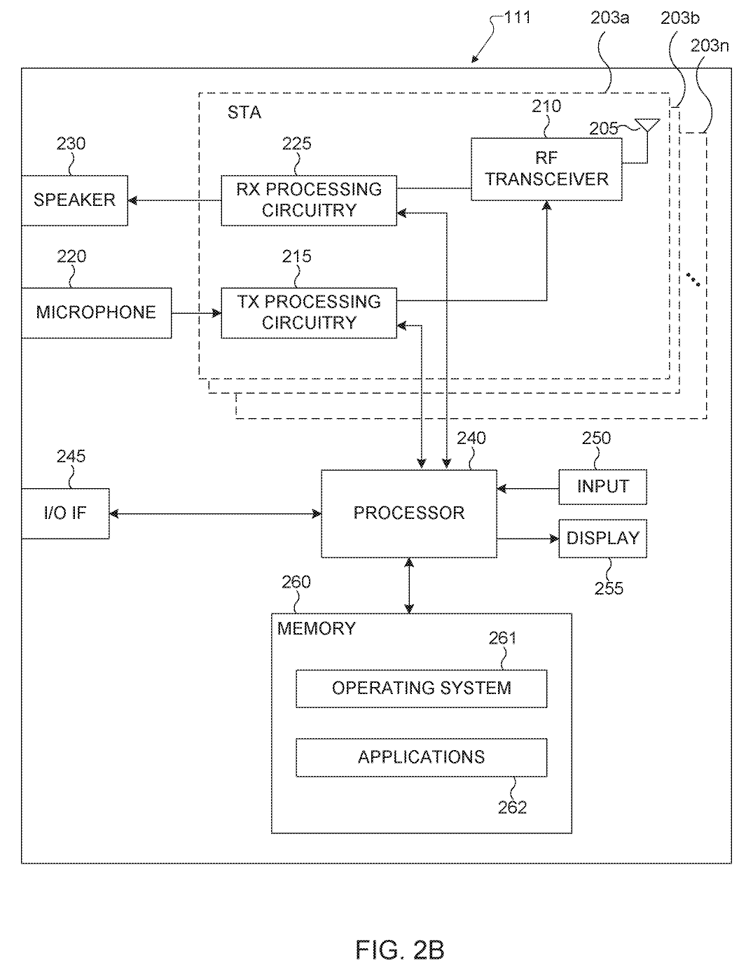

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple radio frequency (RF) transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including a P2P group trust verification mechanism. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for a P2P group trust verification mechanism. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate P2P group trust verification. In some embodiments, the processor 240 includes at least one microprocessor or microcontroller.

The processor 240 is also capable of executing other processes and programs resident in the memory 260, such as operations for P2P group trust verification. The processor 240 can move data into or out of the memory 260 as required by an executing process. In some embodiments, the processor 240 is configured to execute a plurality of applications 262, such as applications for P2P group trust verification. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize that next generation WLAN system needs to provide better support for low-latency applications. It is not uncommon to observe numerous devices operating on the same network. Many of such devices may be latency-tolerant but still contend with the devices with low-latency applications for the same time and frequency resources. In some cases, the AP as the network controller may not have enough control over the unregulated/unmanaged traffic that contend with the low-latency traffic within the infrastructure BSS. Some of the unmanaged traffic that interfere with the AP’s BSS’ latency sensitive traffic may be coming from uplink (UL)/downlink (DL) or direct link communications within the infrastructure basic set service (BSS) that the AP manages; others may be due to transmission in the neighboring infrastructure BSS (OBSS); yet others may be coming from neighboring independent BSS or P2P networks. The next generation WLAN system needs mechanisms to better handle the unmanaged traffic in order to prioritize the low-latency traffic in the network.

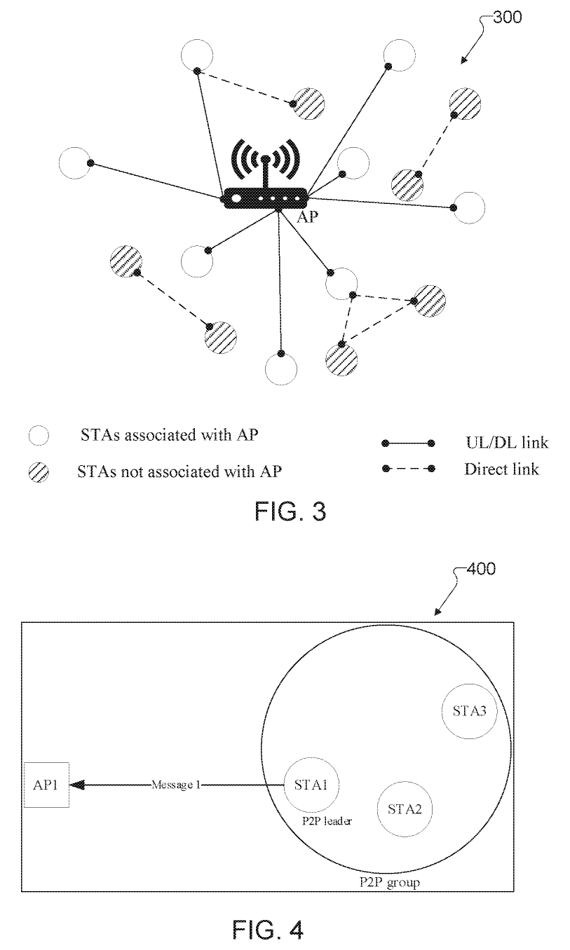

FIG. 3 illustrates an example of a network 300 where infrastructure traffic and non-infrastructure traffic coexist according to various embodiments of this disclosure. The network 300 shown in FIG. 3 is for illustration only. Other embodiments could be used without departing from the scope of this disclosure. Peer-to-peer (P2P) communication represents a significant advancement in IEEE 802.11 wireless local area networks (WLANs), commonly known as Wi-Fi. Traditionally, Wi-Fi networks rely on an access point (AP) to mediate communications between devices. In contrast, P2P communication enables direct data transmission between devices without the need for an intermediate AP. This direct communication is facilitated by standards such as Wi-Fi Direct, which allows devices to establish connections and communicate directly, enhancing efficiency and reducing latency.

The concept of P2P groups extends this capability, enabling multiple devices to form a network where each device can communicate directly with every other member of the group. This setup is particularly useful for applications like file sharing, multiplayer gaming, and streaming media within a local network. The formation of such groups typically involves discovery mechanisms that allow devices to identify potential peers and negotiate group membership. Security is paramount in these groups, ensuring that only authorized devices can join and participate.

The benefits of P2P groups are numerous. By eliminating the need for an AP, they reduce latency and conserve battery life on devices. This makes them ideal for scenarios requiring real-time communication or energy efficiency. Additionally, P2P groups enable innovative applications such as smart home systems and IoT networks, where direct device interaction is crucial.

Despite these advantages, challenges exist in managing P2P groups. Coordinating multiple devices without a central AP requires sophisticated mechanisms to allocate resources like bandwidth fairly. Ensuring seamless group management when devices join or leave is also essential to maintain uninterrupted communication.

Standards within the 802.11 family, such as Wi-Fi Direct and potentially other specifications like 802.11z, provide the framework for these P2P capabilities. These standards ensure compatibility and security, often incorporating encryption methods like Wi-Fi protected access (WPA) encryption such as WPA2 or WPA3 to protect data integrity.

In terms of addressing and routing, devices in a P2P group utilize unique identifiers such as MAC addresses to target communications accurately. This ensures that data packets reach their intended destinations without confusion.

While P2P groups operate independently of an AP for data transmission, the role of the AP may still be relevant for initial authentication or resource management, ensuring a smooth and secure communication environment.

P2P communication among Wi-Fi client devices has quietly become one of the most consequential “second networks” in modern wireless systems. While the BSS—an AP coordinating multiple STAs—remains the dominant connectivity model, a huge and growing fraction of real user value comes from device-to-device interactions that either bypass the AP’s data plane or use the AP only as a facilitator for discovery, security, and policy. Wi-Fi Direct, Wi-Fi Aware (NAN), TDLS (and more generally “D2D over Wi-Fi” patterns), and various vendor-specific derivatives all exist because they solve a practical problem: the endpoints that want to exchange time-sensitive, high-volume, or context-local data are often in the same room, on the same table, or in the same pocket. In those moments, forcing every byte to hairpin through an AP—possibly across congested uplinks, power-saving schedules, and cloud detours—creates avoidable latency, jitter, and energy waste. P2P is a structural pillar of how users experience collaboration, media, gaming, sensing, and control in homes, offices, factories, vehicles, and public spaces. And because P2P traffic still shares spectrum, time, and interference with the infrastructure BSS (and with neighboring BSSs), the quality users perceive depends critically on how well the infrastructure and P2P networks coordinate their operation.

P2P can be used not only as a replacement for the infrastructure network, but as a complementary connectivity layer optimized for proximity. Consider the basic economic reality of radio resources: airtime is the currency, and the medium is shared. When two devices are close, a direct link can often use a higher modulation and coding scheme (MCS), fewer retransmissions, and shorter on-air time per bit than an AP-mediated path that might require two separate hops (STA→AP and AP→STA) plus additional contention. This translates into higher effective throughput and lower latency for the same spectral footprint—assuming the link is scheduled and controlled intelligently. P2P also avoids needless backhaul dependency for local interactions, improves privacy for local-only exchanges, and enables resilient operation when WAN access is degraded. These experiences are built atop a mix of discovery mechanisms, security associations, and data paths that frequently rely on Wi-Fi P2P primitives because of their performance and power characteristics.

Wi-Fi Direct is a visible example: it creates a P2P group where one device becomes a P2P Group Owner (GO), effectively acting like a lightweight AP for the group. This model is used for screen casting, printer access, camera-to-phone transfers, on-site provisioning, and temporary collaboration when an infrastructure network is absent or untrusted. From a system standpoint, the GO role has two purpose: it makes the group manageable using familiar AP/STA semantics, but it also concentrates scheduling responsibility and power drain on a battery device. That is precisely why coordination with an infrastructure AP—when available—matters. If the phone is simultaneously a STA in the infrastructure BSS and a GO for a P2P group, it becomes a multi-role device with potentially conflicting timing obligations: beacons, delivery traffic indication message (DTIM) intervals, power save doze/wake patterns, and enhanced distributed channel access (EDCA) contention all interact. Without careful coordination, one role’s latency and reliability can collapse under the other role’s duty cycle and contention.

Wi-Fi Aware (NAN) addresses a different but equally important dimension: discovery and context. Modern systems increasingly depend on for smart home onboarding, proximity-based sharing, multiplayer gaming lobbies, ad-hoc collaboration, retail experiences, and certain IoT workflows. NAN provides an efficient, low-power framework for devices to publish/subscribe services and discover peers without continuous scanning overhead. But discovery is not independent of QoS; it is the first step of a workflow that often escalates quickly into data transfer, session control, and real-time interaction. A device might discover a peer while it is already engaged in infrastructure traffic that is delay-sensitive, such as voice, video conferencing, cloud gaming, or uplink sensor telemetry. If discovery and subsequent P2P session establishment are not coordinated with the infrastructure BSS’s scheduling and admission control, the system can suffer: a new P2P session begins, consumes contention opportunities, triggers channel switching or off-channel activity, and suddenly the ongoing infrastructure flows experience jitter and packet loss. In well-designed systems, the AP and devices treat P2P initiation not as an isolated event but as a managed resource allocation decision.

TDLS is historically associated with enabling a direct link between two STAs that are already associated to the same AP, with the AP helping set up the security context and link parameters. Conceptually, it is a clean demonstration of the coordination principle: even if the data path becomes direct, the infrastructure association remains important for authentication, policy enforcement, and overall medium coordination. Although TDLS adoption has been uneven in consumer ecosystems, the underlying idea remains relevant: the “infrastructure network” is not merely a relay; it is the control plane anchor that can arbitrate coexistence between multiple types of traffic and roles. In practice, many modern platforms implement “TDLS-like” behaviors under different frameworks, especially in enterprise or specialized deployments, because the performance gains can be significant when two devices are close, but the AP is far or congested.

The use cases driving P2P importance have expanded far beyond classic file transfer. The wireless display, multi-room audio synchronization, camera offload, and collaborative editing all benefit from low-latency, high-throughput local links. Gaming is even more demanding: local multiplayer, spectator streaming, and mixed reality experiences often require tight latency bounds and predictable jitter. In augment reality/virtual reality (AR/VR) and spatial computing, motion-to-photon pipelines can tolerate only small bursts of delay before users perceive nausea or discomfort; local P2P links can reduce end-to-end latency by avoiding unnecessary uplink/downlink contention through the AP and by enabling more direct, higher-rate PHY conditions. In the smart home, smart locks, doorbells, cameras, and hubs frequently use local device-to-device coordination for setup, handoff, and fallback control when cloud connectivity is down. In industrial and healthcare environments, local device swarms—tools, scanners, sensors, displays—need robust, policy-driven interactions that can’t rely on an internet round trip. Vehicles are emerging as major Wi-Fi P2P consumers as well, with in-cabin hotspots, device pairing, keyless entry ecosystems, and sensor-assisted experiences that all lean on proximity communication and low-latency coordination.

All of those scenarios share one hard constraint: the radio channel is still shared, and contention-based access is inherently stochastic. P2P sessions overlap with infrastructure sessions, and they often occur in exactly the moments when users are already pushing the network—video calls, streaming, cloud sync, and background updates. This is why close coordination between the infrastructure network and the P2P network is essential; it is the practical requirement for predictable Quality of Service (QoS). In an unmanaged coexistence model, P2P simply becomes “more contenders,” and the system degrades toward the worst-case behavior of carrier-sense multiple access with collision avoidance (CSMA/CA) under high load: increased collisions, backoff inflation, variable queuing delay, and poor tail latency. Modern use case/experiences demand bounded latency and consistent throughput in environments where the offered load and interference can change abruptly. Coordination is how those demands are reconciled with a shared medium.

Coordination starts with awareness of roles and traffic classes. When a device is simultaneously a STA in an infrastructure BSS and a participant in a P2P session—whether as a Wi-Fi Direct GO, a P2P client, or a NAN participant has to multiplex its radio time across multiple logical networks. If this multiplexing is left to ad hoc scanning and best-effort contention, QoS will be fragile. A coordinated system, by contrast, treats the device as a multi-link, multi-role actor with explicit time budgets and priorities. Even without introducing new primitives, coordination can leverage existing constructs: aligning service periods, synchronizing wake times, managing off-channel operations, and ensuring that high-priority traffic (voice, control, interactive video) is protected from disruption when P2P sessions start or change state. Importantly, coordination is not just about protecting infrastructure traffic from P2P; it is equally about protecting P2P traffic from the infrastructure BSS when the P2P flow is the one that is latency-critical. In a casting session, the P2P stream might be the dominant user experience, and infrastructure background sync should not be allowed to create stutter.

A major coordination challenge is that infrastructure APs and P2P groups can have different beaconing and power-save rhythms. Infrastructure networks typically have established beacon intervals, DTIM periods, and potentially scheduled access mechanisms, while Wi-Fi Direct groups have their own beacon cadence and client power-save behavior. If a dual-role device must maintain synchronization with both, it can end up forced into frequent wakeups, increased overhead, and higher contention, which degrades both battery life and QoS. Coordinated operation aims to reduce this cadence mismatch. Practically, that can mean aligning group beacon timing with infrastructure beacons when feasible, using negotiated absence periods where a device can temporarily prioritize one role without disrupting the other, and ensuring that transitions—such as channel switches or role handoffs—occur at predictable points that minimize collisions and missed delivery opportunities. When coordination is done well, the system behaves more like a scheduled network at the moments that matter, while still retaining the flexibility and interoperability of contention-based access.

Another coordination dimension is channel and bandwidth selection. P2P technologies often select channels based on discovery outcomes, device capabilities, and regulatory constraints, but in dense environments the “best” channel for P2P may be tightly coupled to the infrastructure channel plan. If the infrastructure BSS is operating on a congested channel, starting a P2P session on that same channel may be convenient but harmful to both flows; starting on a different channel might improve throughput but introduces multi-channel concurrency requirements and potential scanning/off-channel overhead. Good coordination is therefore about system-level optimization: where should the P2P session live, how should it share airtime with existing infrastructure flows, and how to reduce disruptive channel switching. In enterprise deployments, the AP may have visibility into load and interference and can guide devices toward better choices; in consumer environments, platform-level coordination (between STA and P2P managers) becomes crucial. The end goal is consistent: reduce the probability that P2P initiation causes a sudden QoS collapse for either network.

QoS assurance also requires coherent prioritization at the MAC layer. Wi-Fi already has EDCA access categories, and modern implementations map application traffic to these categories to some extent. But when introducing simultaneous infrastructure and P2P operation, simple priority tagging is not enough. A device can prioritize its own outgoing packets, but it cannot directly control the behavior of other contenders, including the AP and other STAs, unless there is a shared coordination framework. This is where close cooperation between the infrastructure AP and P2P roles matters: admission control, airtime fairness policies, and scheduling-like behaviors can be applied with a broader view. If the AP understands that a device is engaged in a P2P session with specific latency requirements, it can adjust its own transmission patterns—downlink bursting, trigger-based opportunities, or simply moderating best-effort traffic—so that the combined system maintains acceptable tail latency. Likewise, if the P2P group owner understands the infrastructure’s constraints, it can shape its beaconing, service periods, and forwarding behavior to avoid starving infrastructure flows.

The need for coordination becomes even more pronounced as users move into “multi-device experiences” and “device clouds.” A phone may be simultaneously connected to a home AP, maintaining a low-latency P2P link to a television (TV) for casting, coordinating with earbuds over a different wireless technology, and participating in discovery for nearby devices. But absent coordination, the system can exhibit pathological interactions: off-channel discovery causing missed beacons, power-save transitions causing bursty latency, P2P group maintenance causing periodic contention spikes, and uplink congestion causing downlink stalls. In other words, P2P and infrastructure operation can create each other’s worst-case behavior unless the control plane explicitly manages concurrency.

From a broader technology perspective, P2P is also a foundational enabler for edge intelligence and distributed sensing. Modern devices increasingly collaborate: cameras and phones performing joint capture, phones and laptops co-processing artificial intelligence (AI) workloads, wearables streaming sensor data to a nearby hub for inference, and home devices coordinating automations without cloud round trips. Coordination between infrastructure and P2P networks is what allows these edge workflows to coexist with traditional internet traffic. It is also what allows security and policy to remain coherent. Infrastructure APs often represent the policy boundary for a home or enterprise network: authentication, authorization, and device onboarding policies live there. If P2P sessions form and exchange data outside that boundary without coordination, administrators lose visibility and control, and users can encounter inconsistent security experiences. A coordinated design can keep P2P efficient while still respecting the infrastructure’s policy intent.

Many modern P2P technologies work in groups or clusters, where multiple P2P STAs within the P2P group or cluster work collaboratively within the group. When coordinating with the infrastructure network, the AP can allocate channel resources (e.g., time or transmission opportunity (TXOP)) to the P2P group so that QoS requirement of the P2P group is satisfied.

A first STA that is a member of a P2P group can request for TXOP from the associated AP for other STAs in the same P2P Group. However, currently, there is no mechanism for the AP that can validate the trust relationship between the first STA and the other STA. In other words, a mechanism is needed with which the AP can validate the membership of all the STAs in the P2P group for which the resources (e.g., transmit opportunity or TXOP) have been requested from the AP.

FIG. 4 illustrates a peer-to-peer group 400 according to various embodiments of the present disclosure. The embodiment of the P2P group 400 shown in FIG. 4 is for illustration only. Other embodiments of the P2P group 400 could be used without departing from the scope of this disclosure.

In one or more embodiments, as shown in FIG. 4, STA1 (also referred to herein as the “first STA”) can act as a leader (“P2P leader”) or representative of the P2P group. STA1 can send a group resource request (also referred to herein as the “first message” or “Message 1”) to the associated AP. In the group resource request, STA1 can identify STA2 (also referred to herein as the “second STA”) and STA3 (also referred to herein as the “third STA”). In one or more embodiments, STA1 can indicate to the AP1 (also referred to herein as “the first AP”) that STA2 and STA3 are in the same P2P group as STA1.

In one or more embodiments, all or a subset of the identified other STAs in the P2P group can also be associated with the same AP (AP1). As shown in FIG. 4, STA2 and STA3 may also be associated with AP1 (STA1 is associated with AP1) In other embodiments, all or a subset of the identified other STAs in the P2P group can be associated with AP(s) different than the first AP. According to yet another embodiment, all or a subset of the other identified STAs may not be associated with any AP at all.

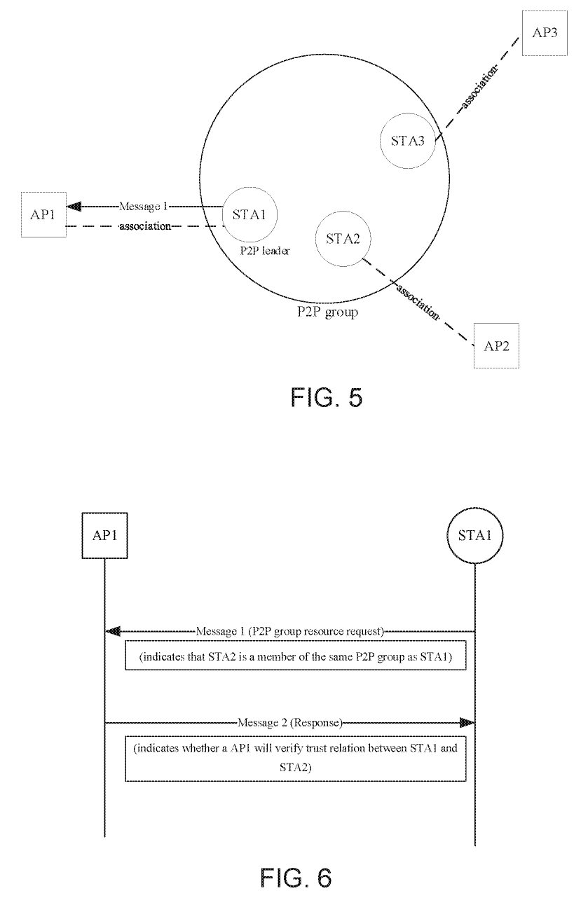

FIG. 5 illustrates a peer-to-peer group 500 according to various embodiments of the present disclosure. The embodiment of the P2P group 500 shown in FIG. 5 is for illustration only. Other embodiments of the P2P group 500 could be used without departing from the scope of this disclosure.

In one or more embodiments, STA2 and STA3 may not be associated with AP1. As shown in FIG. 5, STA2 and STA3 may be associated with other different APs (e.g., STA2 is associated with AP2 and STA3 is associated with AP3). Furthermore, in one or more embodiments, STA2 and STA3 may be associated with another same AP (e.g., AP2).

As noted above, in order to identify other STAs in the P2P group, the first STA can include association ID (AID) values of the other identified STAs in the P2P group in the group resource request. According to another embodiment, in order to identify other STAs in the P2P group, the first STA can include the MAC addresses and/or association identifications (AIDs) of the other identified STAs in the P2P group in the group resource request.

FIG. 6 illustrates an example procedure for P2P group trust verification according to various embodiments of the present disclosure. The embodiment of procedure for P2P group trust verification shown in FIG. 6 is for illustration only. Other embodiments of the procedure for P2P group trust verification could be used without departing from the scope of this disclosure.

According to one or more embodiments, for the scenario where a first STA that is a member of a P2P group sends a group resource request to its associated first AP identifying the existence of the P2P group for which it requests channel resources such as TXOP, in the group resource request, if the first STA also identifies a second STA that is also a member of the same P2P group (e.g., by including the AID or MAC address of the second STA), then upon receiving the request from the first STA, the first AP can send a second message (referred to herein as a “response” or “Message 2”) to the first STA as a response to the group resource request frame received from the first STA. In the response frame, the first AP can indicate whether the first STA has accepted, rejected, or suggested an alternative set of the parameters for the requested channel resource (e.g., TXOP). According to one embodiment, the first AP can also indicate whether the first AP needs to verify with the second STA about the validation of the trust relationship between the first STA and the second STA.

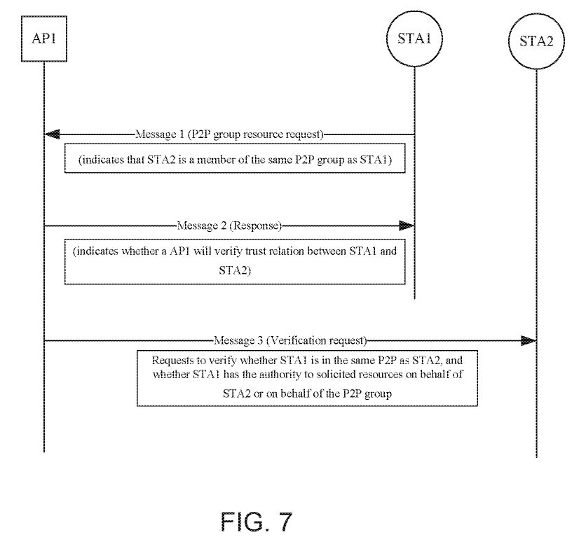

FIG. 7 illustrates an example procedure for P2P group trust verification that includes a verification request according to various embodiments of the present disclosure. The embodiment of procedure for P2P group trust verification shown in FIG. 7 is for illustration only. Other embodiments of the procedure for P2P group trust verification could be used without departing from the scope of this disclosure.

According to one or more embodiments, for the scenario where a first STA that is a member of a P2P group sends a group resource request to its associated first AP identifying the existence of the P2P group for which it requests channel resources such as TXOP, in the group resource request, if the first STA also identifies a second STA that is also a member of the same P2P group (e.g., by including the AID or MAC address of the second STA), then upon receiving the group resource request from the first STA, the first AP can send a verification request (also referred to herein as a “third message” or “Message 3”) to the second STA requesting the second STA to verify the trust relationship with the first STA.

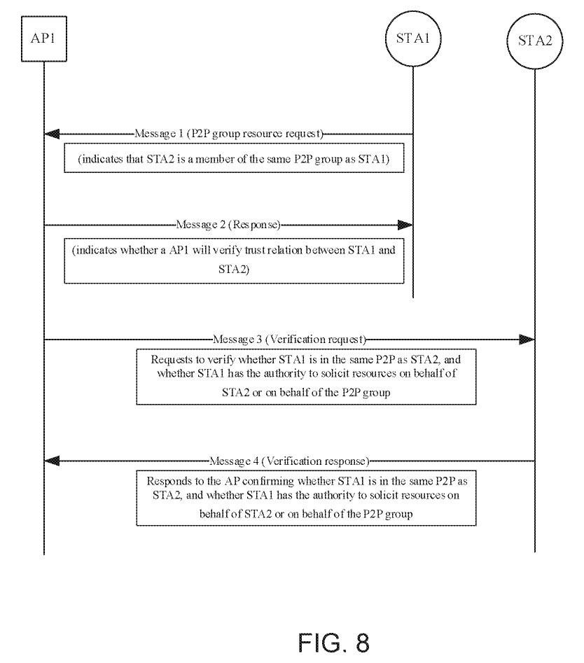

FIG. 8 illustrates an example procedure for P2P group trust verification that includes a verification in response to a verification request according to various embodiments of the present disclosure. The embodiment of procedure for P2P group trust verification shown in FIG. 8 is for illustration only. Other embodiments of the procedure for P2P group trust verification could be used without departing from the scope of this disclosure.

According to one embodiment, for the scenario where a first STA that is a member of a P2P group sends a group resource request to its associated first AP identifying the existence of the P2P group for which it requests channel resources such as TXOP, in that group resource request, if the first STA also identifies a second STA that is also a member of the same P2P group (e.g., by including the AID or MAC address of the second STA), and upon receiving the group resource request from the first STA, if the first AP sends the verification request to the second STA requesting the second STA to verify the trust relationship with the first STA, then upon receiving the verification request from the first AP, the second STA can send a verification response (also referred to herein as a “fourth message” or “Message 4”) to the first AP indicating the validity of the trust relationship between the first STA and the second STA.

In one or more embodiments, the AP may consider energy efficiency when allocating resources to P2P groups. The response (Message 2) from the STA1 could include information about the battery levels of STAs within the group. This allows the AP to prioritize resource allocation to devices with lower battery life, ensuring efficient power management and prolonging network activity for all members.

In one or more embodiments, data priority within the P2P group can influence resource allocation. The response may specify priority levels for different data types or applications, enabling the AP to schedule TXOPs that cater to time-sensitive traffic, thus optimizing performance for critical communications.

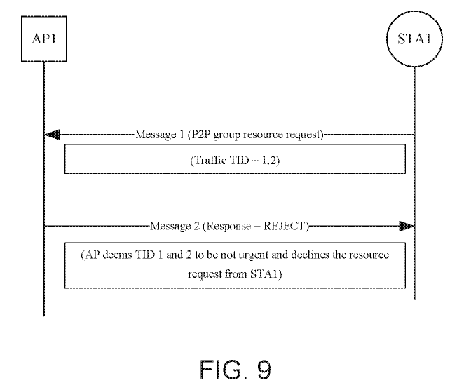

FIG. 9 illustrates an example procedure for P2P group trust verification that is based on a traffic identifier according to various embodiments of the present disclosure. The embodiment of procedure for P2P group trust verification shown in FIG. 9 is for illustration only. Other embodiments of the procedure for P2P group trust verification could be used without departing from the scope of this disclosure.

In one or more embodiments, as shown in FIG. 9, when sending the group resource request to the AP, the first STA can include traffic identifier (TID) value that would correspond to the traffic that would be transmitted by the member of the P2P group. The TID value would indicate the priority of the traffic within the P2P group. For example, for the scenario where the first STA indicates to the AP that TID 1 and TID 2 are the TIDs corresponding to the traffic in the P2P group for which the resources have been requested from the AP, then the AP may deem this traffic as non-urgent, and hence may decline the resource request in the response for that P2P group.

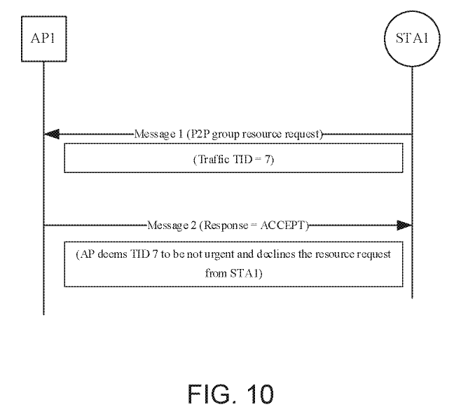

FIG. 10 illustrates an example procedure for P2P group trust verification that is based on a traffic identifier according to various embodiments of the present disclosure. The embodiment of procedure for P2P group trust verification shown in FIG. 10 is for illustration only. Other embodiments of the procedure for P2P group trust verification could be used without departing from the scope of this disclosure.

On the other hand, as shown in FIG. 10, if the first STA indicates TID 7 to be the TID of traffic for which resource has been requested by the P2P group in the group resource request, then the AP may deem this P2P group traffic to be urgent and may accept the request to grant resources (i.e., transmit opportunity (TXOP)) to the P2P group in the response.

According to another embodiment, when sending the group resource request to the AP requesting resources for the P2P group, the first STA can also indicate additional parameters in order to indicate the urgency of the traffic in the P2P group for which the resources have been requested. The additional parameter can include, but are not limited to, user priority (UP) of the traffic in the P2P group for which resource (TXOP) has been requested, the delay bound, the mean data rate or the like. UP may include a user priority value (0–7) data frames that are described herein. The UP can be set to the value of the UP subfield in the Intra-Access Category Priority element in the Intra-Access Category Priority element in the stream classification service (SCS) Descriptor element included in the SCS Request frame, which is used as the group resource request by the first STA to request for resources (TXOP) for the P2P group. The delay bound may contain an unsigned integer that specifies the maximum amount of time, in micro- seconds, targeted (see the MAC service data unit (MSDU) Delivery Ratio field for more details on the delay and the targeted deliver ratio) to transport an MSDU or aggregate MSDU (A-MSDU) belonging to the traffic flow in the P2P group, measured between the time marking the arrival of the MSDU, or the first MSDU of the MSDUs constituting an A-MSDU, at the local MAC sublayer from the local MAC service access point (MAC SAP) and the time of completion of the successful (re)transmission of the MAC protocol data unit (MPDU) containing the MSDU to the destination by a member of the P2P group. The completion time of the MSDU or A-MSDU transmission includes the corresponding acknowledgment frame transmission time, if present. The Mean Data Rate may indicate the average data rate specified at the MAC SAP rounded up to the nearest kilobit per second, in units of kilobits per second, for transport of MSDUs or A-MSDUs belonging to the traffic flow with the P2P group for which TXOP has been requested.

In one or more embodiments, secure invitation mechanisms for new STAs into a P2P group can be integrated via the AP. The group resource request could include a secure token or key, allowing the AP to authenticate and invite new members securely, ensuring that only authorized devices join the P2P group.

In one or more embodiments, dynamic scheduling based on network conditions can enhance resource management. The AP may adjust TXOP allocations in response to congestion levels, switching strategies between peak and off-peak times to maintain efficient resource usage without compromising performance.

In one or more embodiments, integration with mesh networks allows STAs within a P2P group to act as relays, enhancing coverage and connectivity. The AP can optimize resource allocation for these relayed communications, ensuring smooth data transmission across the extended network.

In one or more embodiments, application-based resource allocation can be implemented by including information about the types of applications or services used by the P2P group in the group resource request. This enables the AP to tailor TXOPs and QoS parameters to best support the expected traffic, whether for video streaming, file transfers, or other activities. According to one embodiment, for this purpose, the first STA may include a QoS Characteristics element in the request sent to the AP. The QoS Characteristics element would contain various parameters that would describe the traffic need in the P2P group for which the resource/TXOP has been requested. Based on the traffic pattern included in the QoS Characteristics element, the AP may decide whether to grant or deny the group resource request.

In one or more embodiments, error handling and retransmission strategies can be optimized based on resource allocations from the AP. By minimizing retransmissions through efficient scheduling, the overall network efficiency is improved, ensuring reliable communication within the P2P group.

In one or more embodiments, beamforming techniques can direct transmissions specifically to P2P group members, reducing interference and improving throughput. The AP may use multiple antennas to focus signals, enhancing the quality of data transmission for each STA in the group.

In one or more embodiments, historical usage patterns can inform future resource allocation decisions. The group resource request from the STA could include past performance metrics, enabling the AP to anticipate and prepare for typical traffic loads, ensuring more efficient resource management over time.

In one or more embodiments, dynamic load balancing across multiple APs can be triggered by the group resource request if an AP is overloaded. This allows redistribution of STAs and P2P groups to nearby APs, maintaining optimal network performance and preventing congestion bottlenecks.

In one or more embodiments, feedback mechanisms within the group resource request allow STAs to provide performance metrics to the AP, enabling dynamic adjustments in resource allocation for better network efficiency and user experience for the traffic in the P2P group.

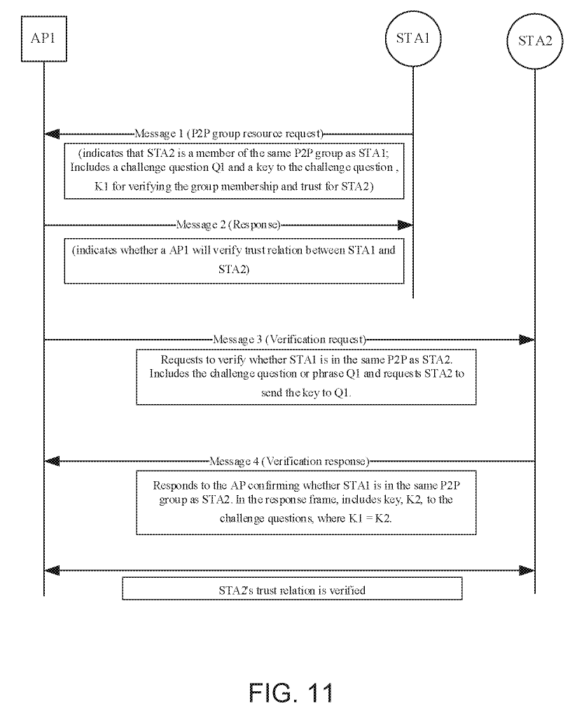

FIG. 11 illustrates an example procedure for P2P group trust verification that is based on a challenge question and/or an identifier according to various embodiments of the present disclosure according to various embodiments of the present disclosure. The embodiment of procedure for P2P group trust verification shown in FIG. 11 is for illustration only. Other embodiments of the procedure for P2P group trust verification could be used without departing from the scope of this disclosure.

In one or more embodiments, as shown in FIG. 11, the first STA can include a key to the challenge question and/or an identifier (e.g., a secure token or key) expected from the second STA for trust verification in the group resource request.

When the first STA identifies the second STA in the P2P group by including its AID or MAC address in the group resource request, the first AP may use this information to verify the membership and trust relationship dynamically. The verification request sent by the first AP to the second STA could include the challenge question or nonce, and/or a request for an identifier requiring the second STA to respond with a signed token or cryptographic proof of its identity and trust status. This ensures that both STAs are authenticated and authorized within the P2P group before resource allocation is granted. The first AP may determine that the second STA is part of the P2P group based on a received answer to the challenge question matching the key to the challenge question and/or receiving an identifier that matches the identifier provided in the group resource request.

In one or more embodiments, when the second STA responds to the AP in response to the verification request, the second STA can send the verification response to the AP that can include a key (or an answer) to the challenge question and/or an identifier. According to one embodiment, if the key provided by the second STA in the verification response matches with the key provided by the first STA in the group resource request, and/or the identifier matches the identifier in the group resource request, then the AP can confirm that the STA2 is in the same P2P group as STA1; otherwise, the AP may deem that the second STA is not in the same group as the first STA. In one or more embodiments, the AP may send the second STA a verification successful message indicating to the second STA that trust has been established.

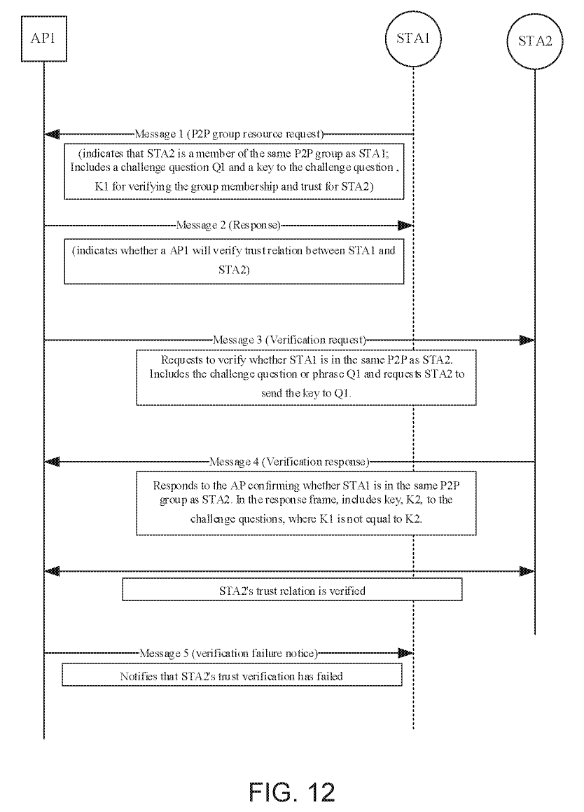

FIG. 12 illustrates an example procedure for P2P group trust verification that is based on a challenge question and/or an identifier according to various embodiments of the present disclosure. The embodiment of procedure for P2P group trust verification shown in FIG. 12 is for illustration only. Other embodiments of the procedure for P2P group trust verification could be used without departing from the scope of this disclosure.

In one or more embodiments, as shown in FIG. 12, if the second STA fails to validate the trust relationship in its response (e.g., by failing to provide a valid signature or token), the first AP may reject the request for channel resources such as TXOP. The first AP could then notify the first STA of this failure via a failure message (also referred to herein as “a fifth message” or “Message 5”), allowing the first STA to take corrective action, such as removing the second STA from the P2P group or re-initiating the trust establishment process.

In one or more embodiments, the verification process can be bidirectional, where both STAs are required to confirm their mutual trust relationship. For example, after receiving the verification response confirming the trust relationship, the first AP could send the success/failure message to the first STA, which then forwards this information to the second STA for an additional layer of validation. This ensures that both endpoints acknowledge and agree to the trust relationship before any resource allocation is finalized.

In one or more embodiments, the trust verification process can leverage cryptographic certificates or public key infrastructure (PKI) mechanisms. The verification request sent by the first AP could include a certificate signing request, requiring the second STA to respond with its public certificate and a signed proof of possession of the corresponding private key. This enhances security by ensuring that only authorized devices with valid credentials can join the P2P group.

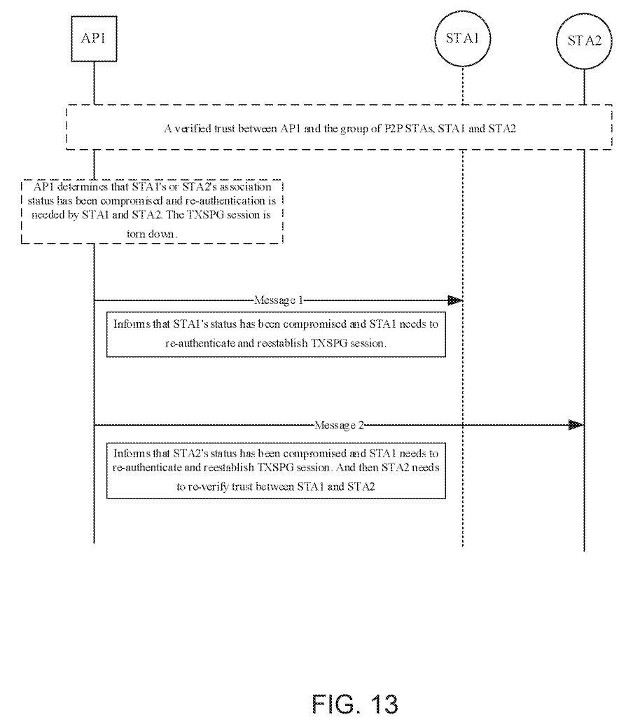

FIG. 13 illustrates an example procedure for P2P group trust verification that includes a revocation of trust according to various embodiments of the present disclosure. The embodiment of procedure for P2P group trust verification shown in FIG. 13 is for illustration only. Other embodiments of the procedure for P2P group trust verification could be used without departing from the scope of this disclosure.

In one or more embodiments, the trust verification process can include a mechanism for revoking trust dynamically. If the second STA is later found to be compromised or unauthorized, the first AP can send a revocation message to both STAs, triggering a re-authentication process or removing the second STA from the P2P group entirely. In one or more embodiments, a first status message can be transmitted from the first AP to the first STA, and a second status message can be the second STA indicating that re-authentication is required.

In one or more embodiments, the trust verification process can be optimized for low latency and overhead by leveraging pre-shared keys (PSKs) or secure tokens. For example, if the first and second STAs have already established a trust relationship through a prior interaction, the third message from the first AP could simply request confirmation of this existing PSK or token, reducing the need for additional cryptographic computations.

In one or more embodiments, the verification process can be extended to include multiple STAs in the P2P group. The first AP may send simultaneous or sequential trust verification requests to all identified STAs, aggregating their responses to determine the overall validity of the group membership and trust relationships before allocating resources like TXOP.

In one or more embodiments, the trust verification mechanism can also consider the physical location of STAs within the P2P group. For example, proximity-based validation techniques, such as measuring signal strength or round-trip time (RTT), could be used to ensure that all STAs are within a trusted geographic range before confirming their membership in the group.

In one or more embodiments, the trust relationship verification process can be tied to quality of service (QoS) parameters. For instance, if the second STA is verified successfully, the first AP may grant higher priority or dedicated TXOP allocations for traffic between the first and second STAs, ensuring low-latency communication within the P2P group.

In one or more embodiments, the trust verification process can be integrated with advanced security frameworks such as Wi-Fi CERTIFIED WPA3. This ensures that the authentication mechanism aligns with industry standards for secure wireless communications while maintaining backward compatibility with legacy devices.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for operating an access point (AP), the method comprising:
receiving a group resource request from a first station (STA), the group resource request indicating that at least one second STA is in a same peer-to-peer (P2P) group as the first STA;
determining whether to verify inclusion of the at least one second STA in the same P2P group as the first STA; and
transmitting a response to the first STA indicating whether the AP needs to verify inclusion of the at least one second STA in the same P2P group as the first STA.

2. The method of claim 1, wherein the group resource request includes at least one of: an association identification (AID), and a Media Access Control (MAC) address of the at least one second STA.

3. The method of claim 1, further comprising transmitting a verification request to the at least one second STA requesting that the at least one second STA verify that the at least one second STA is in the same P2P group as the first STA.

4. The method of claim 3, further comprising receiving a verification response from the at least one second STA confirming that the at least one second STA is in the same P2P group as the first STA.

5. The method of claim 1, wherein:
the group resource request comprises a traffic identifier (TID), and
the method further comprises determining the at least one second STA is in the same P2P group as the first STA based on determining that the group resource request is urgent based on the TID.

6. The method of claim 1, wherein the group resource request further comprises at least one of: a user priority (UP), a delay bound, and a mean data rate of the P2P group.

7. The method of claim 1, wherein:
the group resource request includes a first identifier, and
whether the at least one second STA is in the same P2P group as the first STA is determined based on the first identifier.

8. The method of claim 1, wherein:
the group resource request includes a type of application or service used by the P2P group, and
whether the at least one second STA is in the same P2P group as the first STA is determined based on the application or service used by the P2P group.

9. The method of claim 1, wherein:
the group resource request includes at least one Quality of Service (QoS) characteristic, and
whether the at least one second STA is in the same P2P group as the first STA is determined based on the QoS characteristic.

10. The method of claim 1, wherein:
the group resource request includes past performance metrics of the P2P group, and
whether the at least one second STA is in the same P2P group as the first STA is determined based on based on the past performance metrics.

11. The method of claim 1, wherein the group resource request includes a first identifier and a key to a challenge question, and the method further comprises:
transmitting a verification request to the at least one second STA that includes the challenge question and a request for a second identifier;
receiving an answer to the challenge question and the second identifier from the at least one second STA; and
determining the at least one second STA is in the same P2P group as the first STA based on the answer to the challenge question being the same as the key to the challenge question and the first identifier matching the second identifier.

12. The method of claim 11, further comprising transmitting a verification response to the first STA indicating the P2P group is verified.

13. The method of claim 1, wherein the group resource request includes a first identifier and a key to a challenge question, and the method further comprises:
transmitting a verification request to the at least one second STA that includes the challenge question and a request for a second identifier;
receiving an answer to the challenge question and the second identifier from the at least one second STA;
determining the at least one second STA is not in the same P2P group as the first STA based on the answer to the challenge question being different from the key to the challenge question or the first identifier being different from the second identifier; and
transmitting a failure message to the first STA based on determining the at least one second STA is not in the same P2P group as the first STA.

14. The method of claim 1, further comprising:
determining an association between the first STA and the at least one second STA has been compromised;
transmitting a first status message to the first STA indicating that re-authentication is required; and
transmitting a second status message to the at least one second STA that the P2P group needs to be re-authenticated.

15. A method for operating a first station (STA), the method comprising:
transmitting a group resource request to an access point (AP), the group resource request indicating that at least one second STA is in a same peer-to-peer (P2P) group as the first STA; and
receiving a response from the AP indicating whether the AP needs to verify inclusion of the at least one second STA in the same P2P group as the first STA.

16. The method of claim 15, wherein the group resource request includes at least one of: an association identification (AID), and a Media Access Control (MAC) address of the at least one second STA.

17. The method of claim 15, wherein:
the group resource request comprises a traffic identifier (TID), and
the method further comprises receiving a response from the AP indicating that the at least one second STA is in the same P2P group as the first STA based on the AP determining that the group resource request is urgent based on the TID.

18. The method of claim 15, wherein:
the group resource request includes a first identifier, and
whether the at least one second STA is in the same P2P group as the first STA is determined based on the first identifier.

19. The method of claim 15, wherein:
the group resource request includes at least one Quality of Service (QoS) characteristic, and
whether the at least one second STA is in the same P2P group as the first STA is determined based on the QoS characteristic.

20. The method of claim 15, wherein:
the group resource request includes past performance metrics of the P2P group, and
whether the at least one second STA is in the same P2P group as the first STA is determined based on based on the past performance metrics.
